(19) United States
(12) Patent Application Publication
(10) Pub. No.: US 2010/0099435 A1
(43) Pub. Date: Apr. 22, 2010

(54) METHOD FOR PROVIDING LOCATION-DEPENDENT SERVICES TO TERMINALS OF A RADIO COMMUNICATION SYSTEM

(75) Inventors: Rok Druzinic-Fiebach, Glienicke (DE); Gerald Lehmann, Berlin (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 12/451,274

(22) PCT Filed: Apr. 28, 2008
(86) PCT No.: PCT/EP2008/055170

§ 371 Date: Nov. 4, 2009

(30) Foreign Application Priority Data
May 4, 2007 (EP) 07009069.1

(51) Int. Cl. H04W 24/00; H04B 7/00; H04M 1/00

(52) U.S. Cl. 455/456.3; 455/517; 455/550.1

(57) ABSTRACT

A method provides location-dependent services for a terminal of a radio communication system, wherein the terminal receives information regarding at least one service from a local beacon transmitter, wherein transmissions of the beacon transmitter (BE) are compatible with transmissions of a base station of the radio communication system. The beacon transmitter is located in the radio cell of the base station. The terminal evaluates the received signals and, depending on the result of the evaluation, initiates a connection to a base station of the radio communication system.

### CROSS REFERENCE TO RELATED APPLICATIONS

This application is based on and hereby claims priority to PCT Application No. PCT/EP2008/055170 filed on Apr. 28, 2008 and EP Application No. EP07009069 filed on May 4, 2007, the contents of which are hereby incorporated by reference.

### BACKGROUND OF THE INVENTION

The invention relates to a method as well as system components for provision of location-dependent services to terminals (user equipment) of a radio communication system, as well as to radio stations, especially a beacon transmitter and also user equipment.

Subscribers of radio communication systems which are typically based on the known communications standards GSM (Global System for Mobile Communications) or UMTS (Universal Mobile Telecommunications System) are increasingly to be provided with data of so-called Location-Based Services (LBS). Data of location-based services is exchanged in such cases between specific system components and the user equipment if the subscriber is located in a geographical region in which the service is available and is thus able to be executed for the user station. A few location-based services typically provide for an ongoing comparison between the subscriber's current position and previously determined regions. If the user station is located in one of these regions, a specific service will be activated. This type of service activation is also referred to as location area based triggering. Information about the current location of the user station can be provided using various known positioning methods, as are listed in publications such as EP 1 753 250 A. However expensive positioning methods and possibly the implementation of a positioning receiver in the user equipment are required in such cases.

Radio transmission methods independent of a radio communication system are also already being used to implement location-based services. So-called near-field radio technologies such as Bluetooth, Zigbee, RFID or NFC, which have a typical range of just a few meters, are used for this purpose. For example user equipment equipped with a Bluetooth transceiver device can interact with advertising posters, display windows or advertising hoardings, so that additional information or tips are transmitted to the subscriber over the Bluetooth radio interface to his equipment when he passes by such an area, and if the subscriber is interested he can request further information using a context-sensitive menu. An example of this is described on the Internet page of the service is based on the so-called device discovery protocol of the Bluetooth standard with the aid of which terminals in the vicinity with Bluetooth functionality can be discovered and automatically accessed. A requirement for this however is that the terminal has this additional module and the subscriber has activated this functionality.

### SUMMARY

One possible object is thus to specify a method and also system components which make possible an efficient and low-cost realization of location-based services.

The inventors propose a method for providing location-based services for user equipment of a radio communication system in which the user equipment receives information relating to a least one service from a local beacon transmitter, with transmissions of the beacon transmitter being compatible with transmissions of a base station of the radio communication system in the radio cell of which the beacon transmitter is located. The user equipment subsequently evaluates the received information and, depending on the result of the evaluation, initiates a connection setup to a base station of the radio communication system.

To ensure compatibility between the transmissions of the base station and the beacon transmitter, the beacon transmitter typically uses the same or a part range of the frequency band of the base station and synchronizes its transmissions to the timing structure of the base station. For the typical case of a UTMS standard supported by the base station, the beacon transmitter, as an alternative or in addition, to distinguish its own transmissions from signals of the base station, can also use different spread codes, so-called CDMA codes.

In accordance with a development, the user equipment, when this type of compatibility is provided, uses a transceiver device both for transmitting/receiving signals to/from the base station of the radio communication system and also for receiving the information of the beacon transmitter. This advantageously means that it is not a requirement for receiving location-based services that the user equipment is equipped with additional devices for near-field communication for example, which have to be activated additionally by the subscriber.

In accordance with a further development of the proposal, the user equipment, after setting up the connection to the base station, receives further service-related information from a server via the base station of the radio communication system. This further service-related information will be transmitted by the base station for example in a traffic channel, typically a so-called dedicated channel (DCH) or a channel shared by a plurality of user equipments (shared channel) in accordance with the supported communication standard.

In accordance with the further development the user equipment evaluates the information received from the beacon transmitter by comparing it with a least one user profile stored in the user equipment, whereupon it only initiates the setting up of the connection to the base station if there is a least one match between the received information and parameters of the user profile. The advantageous result achieved by this is that a connection is only set up to a radio communication system if the information offered is of interest for the subscriber. The user profile in this case can typically be configured by the subscriber himself or can also be stored on the system operator side in a SIM (Subscriber Identity Module) card of the subscriber and is accessible for the user equipment. In addition it can be worthwhile or necessary for a subscriber confirmation to have to occur before setting up a connection to radio communication system, for example when realizing payment processes.

In accordance of the further development of the proposal, the information transmitted by the beacon transmitter is transmitted in a broadcast channel which is compatible with a broadcast channel transmitted by the base station. Preferably, in accordance with the further development based on this, there is a reference in the broadcast channel of the base station to the broadcast channel of the beacon transmitter. The broadcast channel of the beacon transmitter can, in the typical case of supporting the UMTS standard, be a so-called S-CCPCH channel, the existence of which is referred to in the so-called broadcast channel (P-CCPCH) or signaling channel PICH of the base station.

In accordance with the further development, the user equipment, in addition to the service related information, receives at least one item of identification information of the beacon transmitter, which the user equipment signals to the radio communication system on setting up a connection to the base station. On the system side this advantageously enables a distinction to be made between a plurality of beacon transmitters located in the radio cell of the base station, so that only the supplementary service-related information involving the specific beacon transmitter will be transmitted to the user equipment. Alternatively, in the same way the identification information of the beacon transmitter can also only be signaled after the connection has been set up to the radio communication system.

In accordance with a further proposed method for providing location-based services for user equipment of a radio communication system, information is transmitted by a beacon transmitter relating to a least one service, with the transmission of the beacon transmitter being compatible to transmissions of a base station of the radio communication system, in the radio cell of which the beacon transmitter is located, and further service-related information is transmitted to the user equipment by the base station of the radio communication system subsequent to a connection setup initiated by a user equipment receiving and evaluating the information of the beacon transmitter.

A beacon transmitter as well as user equipment each have devices with which the methods can be carried out.

### BRIEF DESCRIPTION OF THE DRAWING

These and other objects and advantages of the present invention will become more apparent and more readily appreciated from the following description of the preferred embodiments, taken in conjunction with the accompanying drawing of which:

FIG. 1 depicts a block diagram of system components and also signaling.

### DETAILED DESCRIPTION OF THE PREFERRED EMBODIMENT

Reference will now be made in detail to the preferred embodiments of the present invention, examples of which are illustrated in the accompanying drawing, wherein like reference numerals refer to like elements throughout.

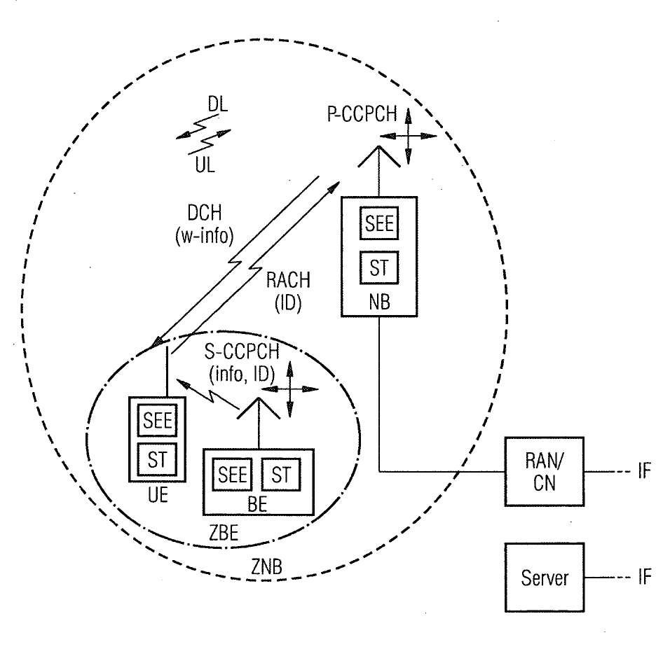

FIG. 1 shows typical components of radio communication system which support the known communications standard UMTS specified within the framework of the 3GPP (3rd Generation Partnership Project). A base station NB (Node B) supplies a least one so-called radio cell ZNB with radio resources and features a least one transceiver device SEE for radio-based communication with User Equipment (UE) located within the radio cell ZNB in accordance with the supported communication standard, as well as a control device ST for controlling the numerous functionalities of the base station NB. The base station NB is connected on the system side to further components of the so-called radio access network (RAN) for example a radio network controller (RNC) and/or a so-called access gateway (aGW) as well as the so-called core network (CN). The core network CN is connected in its turn, for example via an Internet protocol (IP)-based data network, to a server which makes service content available. A data network is typically to be understood as the Internet or a fixed network with circuit-switched or packet-switched connections for example, e.g. for voice and/or data.

Within the geographical coverage area of the radio cell ZNB of the base station NB, in accordance with the example depicted in FIG. 1, there is also a so-called beacon transmitter BE which periodically sends information of a service provider at a low transmission power compared to the transmission power of the base station NB in a geographical region of a radio cell ZBE. This beacon transmitter may possibly also be connected to the server via a data network for access to service-related information currently stored in the server. The beacon transmitter BE is also equipped with a least one transceiver device SEE as well as the control device ST, with it being possible to forego the implementation of a receiver device if the beacon transmitter BE is being used solely to transmit information, but is not however to be designed for interaction with user equipment. The beacon transmitter BE thus at least partly carries out functions of the base station of the radio communication system in accordance with the supported communication standard, without having to be connected to the latter itself. The beacon transmitter BE can be implemented both as a stationary and as a mobile transmitter with, in the case of a mobile beacon transmitter, this being able for example to be implemented as user equipment or as part of the functionality of user equipment.

If a plurality of beacon transmitters are set up relatively close to one another, for example in a plurality of retail outlets of a shopping street in a town, a corresponding coordination of the transmissions of this number of transmitters as well as the base station NB is required in order to avoid mutual negative interference influences. This can occur in the event of the beacon transmitters using an identical radio resource, for example by maintaining a minimum distance, or also by allocating different radio resources, for example different CDMA codes or timeslots for transmissions in accordance with the UMTS standard.

The user equipment UE shown by way of example has a least one transceiver device SEE for radio-based communication with the base station NB or with the beacon transmitter BE in accordance with the supported communication standard, as well as a control device ST for controlling the numerous functionalities of the user equipment UE. The user equipment UE is to example a mobile telephone or also a mobile or stationary facility for transmission of image and/or sound data, for fax, Short Message Service SMS, Multimedia Messaging Service MMS and/or e-mail transmission and/or for Internet access.

The method can advantageously be used in any given radio communication systems. Radio communication systems here are to be understood as systems in which data is transmitted between radio stations via a radio interface. The data can be transmitted bidirectional and also unidirectionally in the uplink (UL) or downlink (DL) direction. Radio communication systems are especially any given mobile radio systems, typically according to the GSM (Global System for Mobile Communications) or the UMTS (Universal Mobile Telecommunications System) standard. Future mobile radio systems, for example those of the fourth generation, as well as ad hoc networks, should also be understood as being radio communication systems. Radio communication systems are also typically Wireless Local Area Networks (WLANs) in accordance with the standard IEEE (Institute of Electrical and Electronics Engineers) 802.11a-i, HiperLAN1 and HiperLAN2 (HiperLAN: High performance radio Local Area Network) standard as well as broadband networks with wireless access in accordance with the so-called WiMAX-Standard IEEE 802.16 for example.

In accordance with the example depicted in FIG. 1 it is assumed that the beacon transmitter BE here is set up or mounted in front of a retail outlet or in the immediate vicinity of this retail outlet and transmits information typically concerning current offers of the retail outlet periodically in the immediate vicinity of the retail outlet. The beacon transmitter BE uses the same frequency spectrum as the base station NB in the radio cell ZNB of which the beacon transmitter is mounted. The signals transmitted by the beacon transmitter BE are in this case compatible with the signals transmitted by the base station NB, but emitted however at a comparatively low transmission power. Typically the transmission power should be dimensioned in such cases so that it is impossible for the user equipment UE to receive the signals of the beacon transmitter BE beyond a radius of approximately 5 to 50 m. Compatibility of the transmissions of the beacon transmitter BE is for example ensured by the transmission of the signals being temporally synchronized to the signals of the base station NB and/or the existence of the signals being indicated in the signals of the base station NB, i.e. a reference being signaled about the transmissions of the beacon transmitter. In such cases this type of compatibility has the advantage of both communication with the base station NB of the radio communication system and also with the beacon transmitter being possible with the components present in the user equipment UE, without supplementary radio communication standards or near-field technologies having to be supported and activated.

In accordance with the example depicted in FIG. 1 it is further assumed that the user equipment UE is in so-called idle mode, with the user equipment UE also being able to be in an active mode for realizing the proposed method in the same manner. The idle mode means that the user equipment UE is not maintaining any active connection for transmission of user data to the radio communication system, but a connection for transmission of signaling information exists in this case. The user equipment UE receives signals of the base station NB which the latter transmits in the so-called Broadcast Channel (BCH) or the corresponding Primary Common-Control Physical Channel (CCPCH) or Page Indicator Channel (PICH) signaling channel. Information relevant for the operation of user equipment UE located within the radio cell ZNB of the base station NB is transmitted via the P-CCPCH).

The beacon transmitter BE on the other hand, in accordance with the example depicted in FIG. 1, uses a standard-conformant, specially adapted additional physical channel S-CCPCH (Secondary-Common Control Physical Channel) for the transmission of information. In this case for example the Cell Broadcast Control Channel (CBCH) of the beacon transmitter BE is mapped to the so-called FACH (Forward Access Channel), which in its turn is part of the S-CCPCH. The beacon transmitter BE also typically uses the same radio cell code as the base station NB, in the radio cell ZNB of which the beacon transmitter BE is located.

In accordance with known mechanisms specified according to the UMTS standard, the existence of an SCCPCH and the radio resources on which the channel can be received is signaled to the user equipment UE. With a plurality of existing S-CCPCHs in the radio cell ZNB of the base station NB appropriate information about the number of S-CCPCHs is signaled. After this signaling has been received the user equipment UE attempts to receive signals of the S-CCPCH. Provided, as in the example depicted in FIG. 1, the user equipment UE is located in the radio cell ZBE of the beacon transmitter BE, this should be possible, whereas user equipment located outside the radio cell ZBE of the beacon transmitter, after a plurality of unsuccessful attempts to receive the signals of the S-CCPCH, would stop doing this or only attempt to do it again at periodic intervals.

For a possible receipt of signals of the beacon transmitter BE on the S-CCPCH the user equipment is able to receive useful information contained within it, such as the current offers of a retail outlet given above as examples, or also identifiers to which the subscriber can refer to request further information, and to output it to the user equipment UE via corresponding user interfaces optically and/or acoustically.

In order to prevent undesired information from these types of beacon transmitters being continuously output to the subscriber by the user equipment or to prevent the user equipment autonomously setting up connections to a server, one or possibly also a plurality of so-called user profiles can be configured and stored for example in the user equipment UE. This user profile can in such cases be configured by subscribers themselves to their own requirements and wishes, but can also be configured by the operator of the radio communication system on the basis of predefined profiles offered to the subscriber from which the latter can select. The user profile typically defines interests, preferences, hobbies personal data etc. of the user. The setting up and storage of a user profile as well as its reconciliation with received information can be undertaken for example by the control device ST of the user equipment UE described above, the user profile itself can be stored in a memory device of the user equipment.

Likewise an immediate evaluation of received information info being undertaken as soon as the easier equipment UE is located in the radio cell ZBE of the beacon transmitter BE should also be prevented where possible, since user equipment moving at a higher speed might also impose a signaling load on the radio interface as a result of initiating the connection setup to the radio communication system, although at the time of the possible receipt of supplementary information from the base station NB side it may not even still be in the radio cell ZBE of the beacon transmitter. To this end, for example in connection with the user profile, a time interval can be provided which defines a period within which the user equipment must at least receive information from the beacon transmitter BE, i.e. must remain in the radio cell ZBE of the beacon transmitter BE before a connection setup is initiated.

After receipt of information info in the S-CCPCH the information is compared with the user profile and only if it matches is information output to the subscriber and also where necessary a connection set up to a server. To this end both the useful information of the S-CCPCH and also the entries of the user profile are classified. Thus for example the interest of a female subscriber in women's shoes can be stored in the user profile by specifying the class “S-D” and an associated binary status “1” (=interest), whereas the lack of interest of the female subscriber in man's shoes can be stored in the user profile with the class “S-M” as well as an associated binary status “0” (=no interest). Provided the retail outlet is currently transmitting via the beacon transmitter BE information both in the class “S-D” and also in the class “S-M”, after reconciliation of the information received by the user equipment UE of the female subscriber, only the information for the class “S-D” is transmitted to the user equipment UE of the female subscriber.

As well as a direct transmission of information about current offers of a retail outlet which can be output directly by receiving user equipment it can be sensible, because of too large an amount of such information, for subscribers to only be signaled a small amount of information about current offers, and for detailed information to have to be actively retrieved by the subscribers from the server. In the above example this could be done by the only output to the female subscriber initially being that the retail outlet was currently offering good deals on women's shoes, and more comprehensive information on the topic able be viewed by using a link to a specified Internet page. The selection by the female subscriber of the link to the Internet page world then establish a connection to the radio communication system in accordance with a known protocol of the communications standard, for example using the so-called random access channel (RACH) as well as initiating the server. After completion of the connection setup further service-related information w-info is made available to the user equipment UE from the server via the base station NB, with this for example being transmitted in a so-called dedicated channel (DCH) or in a shared channel used jointly by a plurality of user terminals. Alternatively the female subscriber can use the link to also request that she be sent a known SMS (Short Message Service) MMS (Multimedia Message Service) message with the desired information in greater detail. Since setting up a connection to download data from the server normally results in a charge, it is also sensible for this to have to be initially accepted by the female subscriber if the retail outlet does not accept the costs arising.

Since large volumes of different information are administered as a rule by the server of a service provider, it is sensible, when a connection is established to this server, for the radio communication system to transmit a least one identifier ID of the beacon transmitter received by the beacon transmitter BE as well as if necessary specifications about the desired information. On the basis of this information the server can then provide the information required by the female subscriber.

As well as the use of the method described above for transmission of promotional or other product information to potential customers of a retail outlet, the method can be used in the same way for a location-dependent registration of the user for example or also for payment processes. It is thus conceivable that signals are able to be sent in the foyer of a cinema to the user equipment of patrons, indicating to them that on the one hand they should switch this equipment off during the subsequent performance in order not to disturb other patrons, on the other that by establishing a connection to a server or to a specific Internet page of the service provider, for example the cinema operator, they can pay for their cinema tickets by charging the amount to their telecommunication contract. If the patron then establishes a connection to the server and where necessary provides supplementary information for registering for this process, corresponding charging is then undertaken by interaction on the system side between server and radio communication system.

In order to transmit to the beacon transmitter BE or its S-CCPCH relevant information in broadcast channels such as the P-CCPCH for example or in signaling channels such as the PICH for example, it is necessary for the radio communication system to receive this information. Independently of this information however the configuration of the beacon transmitter BE, especially its compatibility to the signals of the base station NB, in the radio cell ZNB of which it is located, can be undertaken by the beacon itself without a direct connection to the radio communication system. Thus the beacon transmitter, for temporal synchronization of its own transmissions with transmissions of the base station NB, can receive during a one-off or periodically executed initialization phase, the so-called System Frame Number (SFN) of the base station NB, which for example is transmitted in the PCCPCH and serves as a timing reference for all physical channels in the downlink transmission direction of the base station NB. For more details the reader is referred to the technical specification 3GPP TS 25.211 V6.7.0 (12-2005) “Physical channels and mapping of transport channels onto physical channels (FDD) (Release 6)”. The corresponding S-CCPCH transmitted by the beacon transmitter BE should also relate to this time reference to make it possible for user equipment to detect this channel rapidly.

The signals of the beacon transmitter can thus contain information for example about the beacon identity, a classification of the service or the services provided, for example in relation to the content, the registration for the payment, supplementary information or identifications of the service, such as a secondary classification for example for a reconciliation with the user profile and also addresses or telephone numbers for a subsequent connection setup, with this information advantageously also being able to be signaled by identity codes.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for providing a location based service for user equipment of a radio communication system, comprising:
sending radio transmissions from a beacon transmitter located in a radio cell, the radio transmissions of the beacon transmitter being compatible with transmissions of a base station also located in the radio cell;
receiving information at the user equipment via at least one of the radio transmissions from the beacon transmitter, the information relating to the service;
evaluating the information at the user equipment to produce an evaluation result; and
initiating a connection setup from the user equipment to the base station depending on the evaluation result.

16. The method as claimed in claim 15, wherein
the user equipment uses a transceiver device implemented in the user equipment both for transmitting/receiving signals to/from the base station of the radio communication system and also for receiving the information from the beacon transmitter.

17. The method as claimed in claim 15, wherein
the user equipment, after establishing the connection to the base station receives further service-related information from a server via the base station of the radio communication system.

18. The method as claimed in claim 15, wherein
the user equipment evaluates the information received from the beacon transmitter by comparing the information with a user profile stored in the user equipment, and
if there is a match between the information and parameters of the user profile, the user equipment initiates the connection setup to the base station.

19. The method as claimed in claim 15, wherein
the base station transmits over a base broadcast channel, and
the beacon transmitter transmits the information over a beacon broadcast channel which is compatible with the base broadcast channel.

20. The method as claimed in claim 19, wherein
the base station transmits a reference to the beacon broadcast channel on the base broadcast channel or a signaling channel of the base station.

21. The method as claimed in claim 15, wherein
the beacon transmitter sends the user equipment identification information that identifies the beacon transmitter, and
when a connection is set up to the base station, the user equipment signals the identification information to the radio communication system.

22. A beacon transmitter located in a radio cell of a radio communication system together with a base station of the radio communication system, comprising:
one transmit device to transmit radio transmissions that are compatible with transmissions of the base station, at least one of the radio transmissions containing information relating to a service; and
a control device to control transmission of the information.

23. A beacon transmitter as claimed in claim 22, further comprising:
a receive device to receive signals of the base station, the control device being designed to evaluate the signals received from the base station and to control transmission of the information relating to the service.

24. The beacon transmitter as claimed in claim 23, wherein
the receive device receives the signals from the base station via a base broadcast channel or a signaling channel of the base station,
the beacon transmitter transmits the information over a beacon broadcast channel, and
the control device controls transmission of the information from the beacon transmitter depending on the signals signals received from the base station.

25. The beacon transmitter as claimed in claim 22, wherein
the control device controls a transmission power of the transmit device such that the information relating to the service is able to be received only in a smaller geographical area than that of the radio cell.

26. User equipment of a radio communication system, comprising:
a transceiver device to receive information from a beacon transmitter and to transmit and/or receive signals to/from a base station of the radio communication system, the information from the beacon transmitter being compatible with signals from the base station, the information from the beacon transmitter relating to a least one location based service, the transceiver device being able to communicate with both the base station and the beacon transmitter only if the user equipment is located both in a radio cell of the base station and also in a radio cell of the beacon transmitter; and
a control device to evaluate the information received from the beacon transmitter and produce an evaluation result and to control setting up of a connection to the base station via the transceiver unit depending on the evaluation result.

27. The user equipment as claimed in claim 26, wherein
the transceiver device is additionally designed to receive further service-related information from the base station.

28. A method for providing a location based service to user equipment of a radio communication system, comprising:
sending radio transmissions from a beacon transmitter located in a radio cell, the radio transmissions of the beacon transmitter being compatible with transmissions of a base station also located in the radio cell, at least one of the radio transmissions from the beacon transmitter including information relating to the service; and
transmitting further service-related information from the base station to the user equipment subsequent to a call setup initiated by the user equipment receiving and evaluating the information of the beacon transmitter.
